(19) United States
(12) Patent Application Publication
(10) Pub. No.: US 2005/0090961 A1
(43) Pub. Date: Apr. 28, 2005

(54) Agricultural product handling system

(75) Inventors: Mark Bonk, Eden Prairie, MN (US); John Schmidt, Eden Prairie, MN (US)

Correspondence Address: CARGILL, INCORPORATED, LAW/24, 15407 MCGINTY ROAD WEST, WAYZATA, MN, 55391, US

(73) Assignee: Cargill, Inc.

(21) Appl. No.: 10/974,705

(22) Filed: Oct. 28, 2004

Related U.S. Application Data
(60) Provisional application No. 60/514,743, filed on Oct. 28, 2003.

(51) Int. Cl. G06F 7/70

(52) U.S. Cl. 701/50

(57) ABSTRACT

A system for handling an agricultural product. The system includes a check-in system adapted to check-in a product carrier driver at a product terminal. The check-in system includes a carrier identification system adapted to identify the product carrier and a product carrier positioning system adapted to determine whether the product carrier is in an acceptable position for product sampling. The system also includes a product sample probe guidance system adapted to guide a product sample probe to and from the product carrier and obtain a sample of product while avoiding obstructions on the product carrier. A product evaluation system adapted to determine the type of sampled product based on a visual image of the product.

### CROSS-REFERENCE TO RELATED APPLICATIONS

This application claims the benefit of and priority to U.S. Provisional Patent Application No. 60/514,743 (incorporated by reference herein) filed on Oct. 28, 2003.

### BACKGROUND

In many instances, agricultural products, such as corn, beans, wheat, etc., are taken to terminals after harvesting by producers or farmers. Typically, carriers, for example, trucks and trains, etc., transport the agricultural products to the terminal where the product is deposited. Such products may be stored at the terminal and/or sold as commodities.

Conventional terminals require extensive personnel support. Terminal operators interface with the drivers of the carriers, manage operations at the terminal, and evaluate the product that is deposited at the terminal to, for example, determine the type and quality of the product or good. Terminal personnel are also required to direct the carriers through the terminal and to ensure proper positioning of the carrier during, for example, product sample extraction and/or dumping. Additional operators may be required to manage the flow of the carriers through the terminal, especially when there are a number of carriers attempting to unload their goods at the terminal at the same time.

In addition, many terminals evaluate the quality of the agricultural products and determine a price based on the determined quality. Additional personnel are typically required for this task.

### SUMMARY

According to an exemplary embodiment, an agricultural product handling system is provided. The system includes a product sampling system configured to automatically obtain a product sample from a transporter and direct the product sample to one of a plurality of screeners (i.e., evaluation devices) based on the type of product being carried by the transporter.

According to another exemplary embodiment of the present invention an agricultural product handling system is provided. The system includes an interface unit adapted to convey information to and accept input from a driver of the carrier. In addition, the system includes a carrier position determining device adapted to determine whether the carrier is in an acceptable position. A product sample probe guidance device adapted to guide a product sample probe to obtain a sample of product is also provided. A product discrimination device is provided in order to analyze sampled product. Preferably, the guidance device includes a bottom sensor adapted to detect the bottom of a carrier container.

According to another embodiment of the present invention a system for handling an agricultural product is provided. The handling system includes a check-in system adapted to check-in a product carrier driver at a product terminal; wherein the check-in system includes a carrier identification system adapted to identify the product carrier using a visual image and a product carrier positioning system adapted to determine whether the product carrier is in an acceptable position for product sampling. The handling system also includes a product sample probe guidance system adapted to guide a product sample probe to and from the product carrier using an visual image and obtain a sample of product while avoiding obstructions on the product carrier; and a product evaluation system adapted to determine the type of sampled product based on a visual image of the product.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a schematic view of a first embodiment of the present invention.

FIG. 2 is a schematic view of a product check-in station according to an exemplary embodiment of the present invention.

FIG. 3 is a schematic view of an identification record according to an exemplary embodiment of the present invention.

FIG. 4. is a schematic view of a sampling station according to an exemplary embodiment of the present invention.

FIG. 5. is a schematic view of a product probe arm according to an exemplary embodiment of the present invention.

FIG. 6 is a schematic view of a product evaluation station according to an exemplary embodiment of the present invention.

FIG. 7 is a schematic view of a product unload station according to an exemplary embodiment of the present invention.

### DETAILED DESCRIPTION

According to one embodiment of the present invention, a terminal is provided. The terminal includes a carrier check-in station; a sampling station; and a product unloading station. The carrier check-in station includes a device adapted to record a visual image of the carrier and assign a code corresponding to the carrier.

According to an alternative embodiment of the present invention, a terminal is provided that includes a check-in terminal adapted to check-in a carrier at a terminal. The check-in terminal may include a carrier delivery receipt scanner; an electronic card dispenser; an interface unit adapted to convey information to and accept input from a driver of the carrier; a license plate identification recognition device adapted to recognize a license plate on the carrier; and a carrier position determining device adapted to determine whether the carrier is in an acceptable position. The terminal may also include a product sample probe guidance device adapted to guide a product sample probe to obtain a sample of product and a product discrimination device adapted to determine the type of sampled product. The guidance device may include a bottom sensor adapted to detect the bottom of a carrier container.

According to a further embodiment of the present invention, the terminal includes a carrier check-in station; a sampling station; and a product unloading station. The terminal is adapted to automatically direct a carrier to an unloading station of the terminal based on a type of product carried by the carrier.

In yet another embodiment of the present invention, the terminal includes a carrier check-in station; a sampling station; and a product unloading station. The product unloading station being adapted to automatically provide a driver of a carrier with results of a quality evaluation of product carried by the carrier.

In various embodiments of the present invention, the carrier sampling station may be adapted to determine the type of product carried by the carrier from an image obtained with a camera. The terminal may be adapted to automatically obtain a product sample from the carrier and direct the product sample to one of a plurality of screeners based on the type of product carried by the carrier. The terminal may include a processor adapted to automatically control a carrier check-in station, a sampling station, and a product unloading station. The processor may be adapted to receive information from a bin board spread sheet and to automatically choose a product bin to which product deposited at the terminal should be directed.

The present invention includes a method of handling an agricultural product with an essentially automated terminal, comprising the following steps: checking-in a carrier by a method including recording a visual image of the carrier and assigning a code corresponding to the carrier; removing a sample of product carried by the carrier from the carrier; transporting the sample of product to a product evaluation station; evaluating the sample of product; and outputting information based on the evaluation of the sample of product.

An alternative method of handling an agricultural product with an automated terminal is also provided. The method includes the following steps: checking-in a carrier at a check-in station of a terminal by a method that includes capturing information from a unique identifier on the vehicle or transporter by viewing the license plate with a camera, electronically recognizing symbols on the license plate viewed by the camera indicative of a government entity from which the license plate was issued and a number of the license plate, generating a digital code representing information about the electronically recognized symbols, and least one of verifying of the identity of the carrier based on the digital code and recording the digital code.

According to various embodiments of the present invention, the method of handling the agricultural product may include removing a sample of product carried by a carrier from the carrier utilizing a robotic product remover. The method may alternatively include directing a carrier to an unloading station of a terminal based on the type of product carried by the carrier, wherein the type of product carried by the carrier is determined based on a visual image captured by a camera of product in the carrier.

In an alternative embodiment a method of handling an agricultural product with a terminal is provided. The method includes the steps of determining whether a carrier carrying product is in a proper position to unload the product carried by the carrier based on an image or a plurality of images of the carrier obtained by a camera; directing a driver of a carrier to re-position the carrier if the carrier is not in a proper position to unload the product carried by the carrier; and directing a driver of a carrier to unload product carried by the carrier.

In yet another alternative embodiment the method includes the steps of: determining the weight of product deposited at the terminal by a method including: determining whether a carrier is located in a position that will allow the carrier to be weighed based on the analysis of information from a scale; weighing a carrier carrying product; weighing the carrier after the carrier has unloaded product; and determining the weight of product deposited at the terminal based on the difference between the weight of the carrier while carrying product and the weight of the carrier after the carrier has unloaded product.

A system for handling agricultural product is also included within the scope of the present invention. The system includes a check-in system adapted to check-in a carrier driver at a terminal. The check-in system includes: a carrier delivery receipt scanner; an identification record dispenser; an interface unit adapted to convey information to and accept input from a driver of the carrier; a license plate identification recognition system adapted to recognize a license plate on the carrier; a carrier positioning system adapted to determine whether the carrier is in an acceptable position for sampling; a product sample probe guidance system adapted to guide a product sample probe to and from the carrier and obtain a sample of product while avoiding obstructions on the carrier; a product discrimination system adapted to determine the type of sampled product based on a visual image of the product; and a carrier container bottom sensing system adapted to detect the bottom of a carrier container.

Alternatively, the product handling system may include a carrier unloading system adapted to enable a carrier to unload a load of product, wherein the unloading system includes: an identification record reader; an interface unit adapted to convey information to and accept input from a driver of the carrier; a carrier positioning system adapted to determine whether the carrier is in an acceptable position to unload the load of product; a product weighing system adapted to determine the weight product unloaded from the carrier.

In an alternative embodiment of the present invention, the system for handling product includes a supervisory system adapted to coordinate a plurality of systems of a terminal, wherein the coordinated systems of the terminal include: a check-in system; a sampling system; a product evaluation system; and an unloading system; and a checkout system.

A more detailed description of the various exemplary embodiments of the present invention with reference to the drawings follows below.

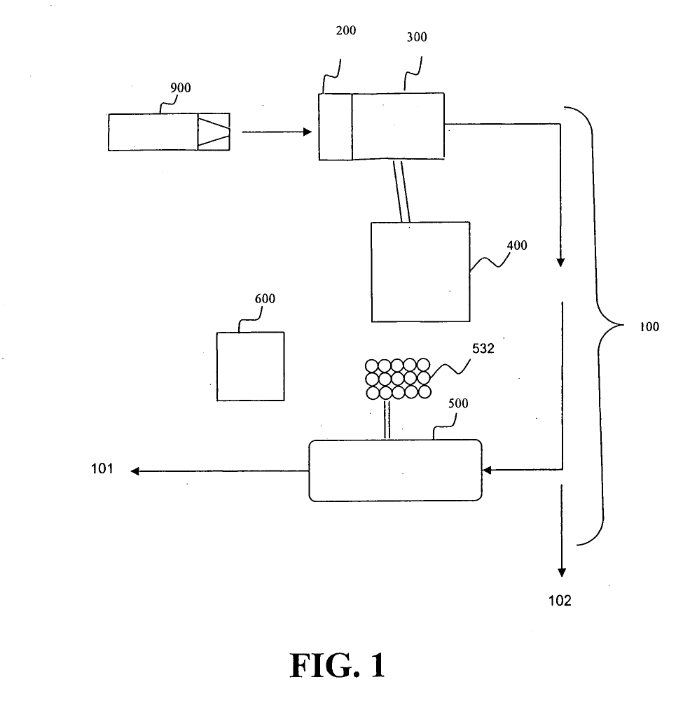

According to an embodiment of the present invention, as shown in FIG. 1, a product handling system or terminal 100 may include a carrier check-in station 200, a carrier sampling station 300, a product evaluation station 400, and a product unloading station 500. The terminal 100 may also include supervisory station 600. As shown in FIG. 1, a carrier 900 enters the carrier check-in station 200 where the driver of the carrier 900 checks in to the terminal 100. According to an embodiment of the invention, the check-in is fully automated. Thus, the driver checks in without the need for terminal personnel to directly interact with the driver during the check-in process. After check in, the driver then proceeds to the sampling station 300 where a sample of product may be automatically removed from the carrier 900. After removal, the sample of product may be transported to a product evaluation station 400 where the product is analyzed. The driver is then directed, to one of a plurality of product unloading stations 500 where the product that the driver is carrying may be unloaded. After the product is unloaded at the unloading station 500, the carrier 900 may exit the terminal through a check-out station. All of these activities are monitored and/or controlled by a supervisory station 600 which is linked to the various stations electronically.

According to an embodiment of the present invention, the various terminal stations are configured to operated automatically so that terminal personnel are not generally required to interact directly with any specific carrier. As a result, the operations relating to receiving a load of product from a carrier can be performed in a more efficient manner. Thus, according to an embodiment of the present invention, the carrier 900 may check-in to the terminal 100, have a sample of product removed and evaluated for quality, and be directed where and when to unload the product automatically. However, terminal personnel may be utilized to perform some or all of the above mentioned tasks.

Specific exemplary features of the terminal will now be discussed in greater detail.

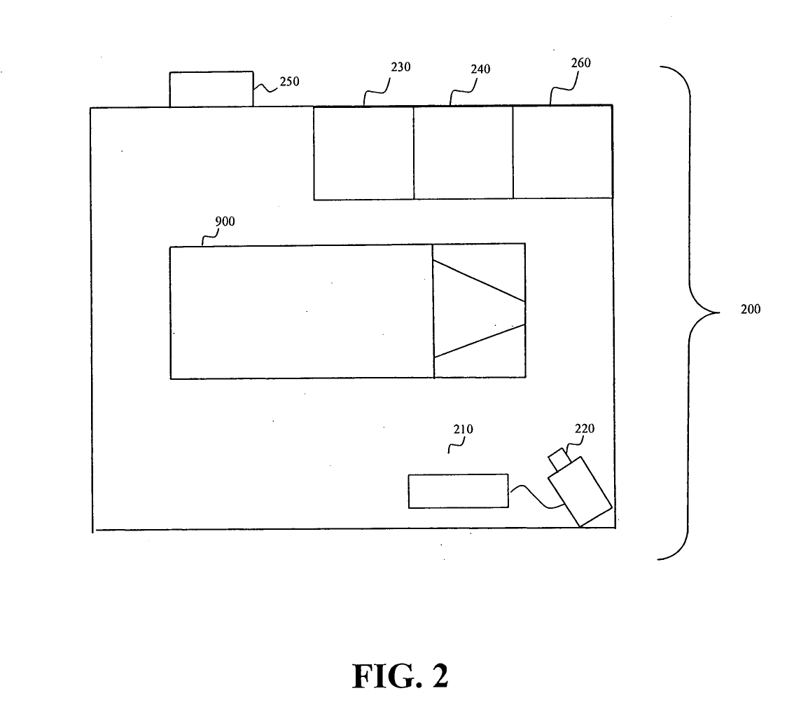

As shown in FIG. 2, the terminal 100 may include a carrier check-in station 200. The check-in station 200 may include a controller 210, which may be a computer, that is adapted to record and/or capture a visual image of the carrier with a camera or other optical device 220 and/or assign a code corresponding to the carrier. The controller 210 may be configured to record a visual image of a unique identifier for the carrier. According to one embodiment, the carrier's license plate is recorded utilizing an input device 200, for example a camera. The camera 220 may be configured to move or adjust automatically so that a clear view of the license plate or other unique identifier can be obtained and an accurate image of the license plate can be captured.

The controller 210 may include a wide angle vision camera system with support software for recognizing and identifying the carrier. For example, the controller 210 may be adapted to recognize symbols on the license plate such as, by way of example, the state/province that issued the license plate and the license plate number on the license plate. The controller 210 may utilize a symbol recognition routine so that the image of the characters contained on the license plate will be recognized and converted into an information data set indicative of the state/province that issued the license plate and/or the license plate number. This data set can be read by a processor or computer 250 (described in detail below), and utilized in a data management system of the terminal.

The controller 210 may also be adapted to record a visual image of the carrier while the driver of the carrier 900 checks in at the check-in station using a camera (e.g., a suitable model from Perceptics Corporation) mounted in an enclosure using a shed at an angle that will permit an image of the license plate to be obtained for most carriers. The image may be recorded, while the driver is inputting information into an input terminal 240, (discussed in greater detail below). The information obtained by the controller 210 will be compared to information obtained on a delivery receipt (discussed in greater detail below) to verify the identity of the driver and/or the carrier 900.

The controller 210 may be connected to a network (e.g., an Ethernet network, which may be wireless, that includes the computer 250 and/or the supervisory station 600, where a record for the carrier 900 is created and stored and where the information obtained from the captured image of the license plate can be correlated with other components of the automated terminal 100. Other forms of communication may be utilized as well.

As shown in FIG. 2, the check-in station 200 may include an input device such as a scanner 230 adapted to scan a delivery receipt. The receipt may be inserted into and/or placed on the scanner by a driver of the carrier 900. The scanner may be a flatbed Microtek 8700 with a document feeder where the driver of the carrier 900 lays his or her delivery receipt ticket on the scanner and then initiates scanning of the delivery receipt. The scanned image is converted to text and the scanned information may be displayed on a delivery receipt screen on a driver's terminal 240 (discussed in greater detail below). Unreadable entries on the delivery receipt, such as, for example, entries that are blurred such that a proper character recognition could not be obtained, or alternatively, the entry is blank, can be identified and the driver can be prompted to input or otherwise correct the missing information on the input terminal 240. Still further, the terminal 240 can be adapted to allow the driver to modify the information obtained from scanning the receipt with or without prompting by the terminal 100.

The check-in station 200 may utilize any device/system that will permit information to be extracted and recognized from a delivery receipt. The check-in station 200 may utilize any specific device/system that will permit information to be extracted from any form of specific record/identification that a driver of a carrier may utilize.

The terminal 100 may also include, as discussed above, an input terminal 240 operably connected to a computer 250 and/or the supervisory station 600. The computer 250 may be adapted to analyze the information obtained by the scan of the delivery receipt and issue a message requesting that a driver of the carrier input the information that was not contained in the scanned delivery receipt. The input terminal 240 may include a terminal display with a touch screen capability and/or an alphanumeric keypad.

The terminal 100 may include any suitable information transfer mechanism that will permit a driver of a carrier 900 to input information and/or receive information from the terminal.

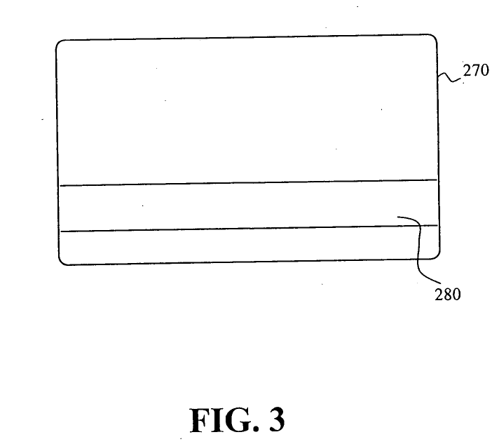

The terminal may also include an output device such as an identification record issuing device 260 that is adapted to dispense an identification record 270 having a memory device 280 such as, for example, a magnetic strip, containing the code assigned to the carrier. As exemplary record 270 is shown in FIG. 3. The identification record issuing device 260 may include a magnetic writer from the Elk Hercules 2000. The issuing device 260 may issue a magnetic card driver that may be used to identify the driver and/or the carrier's load. The memory device 280 may take the form of a variety of devices such as, for example, a bar code and a RFID device. The identification record issuing device may be configured to dispense an identification record 270 having a memory device, but containing information about the type of product carried by the carrier. The memory device 280 may include both the code assigned to the carrier and information about the type of product carried by the carrier. The memory may also include additional information relating to the driver, carrier, product or terminal.

The check-in station 200 may utilize any mechanism that would allow the terminal 100 to issue an identification record and/or impart an identification means to a driver of a carrier 900 and/or the carrier 900 itself.

The check-in station 200 (as well as some or all of the stations described below) may utilize wireless technology, such as by way of example, a wireless Ethernet connection to communicate to other stations/areas of the terminal, as well as other components making up the check-in station and/or other stations of the terminal 100. In addition, the terminal 100 utilize wired technology to communicate between the various stations/areas of the check-in station 200 and/or the components of the check-in station 200 (as well as some or all of the stations described below).

It should be noted that, according to an embodiment of the present invention, the functions of the controller 210 and computer 250 may performed in a single device. Alternatively, separate processors may be provided. Further, in accordance with another embodiment, the controller 210 and/or the computer 250 may be an integral part of a processor associated with the supervisory station 600.

The terminal 100 may be configured to require the license plate number obtained from the captured image of the license to match the license number obtained from the scan of the delivery receipt. The requirement can be met using, for example, a software routine as would readily be understood by one of ordinary skill. Still further, the terminal 100 may be configured to prompt the driver of the carrier and/or terminal personnel to take some form of action to investigate and/or rectify an identified discrepancy.

As noted above, the terminal 100 may include a sampling station 300. The sampling station 300 allows a sample of product to be removed from the carrier 900 so that the product can be transported to the product evaluation station 400 and evaluated for various quality aspects which are discussed in greater detail below. The sampling station 300, enables the type and quality (e.g., grade) of the product to be determined.

The carrier sampling station 300 may be located immediately adjacent to the carrier check-in station 200. Alternatively, the carrier check-in station 300 may be separated by a distance from the carrier sampling station 300. That is, the carrier check-in station 200 and the carrier sampling station 300 may be two distinct separate stations. However, the carrier check-in station 200 and the carrier sampling station 300 may be located in the same area of the terminal. When the carrier check-in station 200 and the sampling station 300 are located in distinct areas, the driver of the carrier 900 drives the carrier 900 from the check-in station 200 to the sampling station 300. The driver may be automatically and/or manually prompted by an output device such as a visual and/or audio message to move the carrier 900 from the check-in station to the sampling station 300 after control logic has determined that the check-in is complete. The completion of the check-in process may be monitored and determined by one of the terminal's processors. Also, prompting of the driver may be initiated by one of the processors of the supervisory station 600.

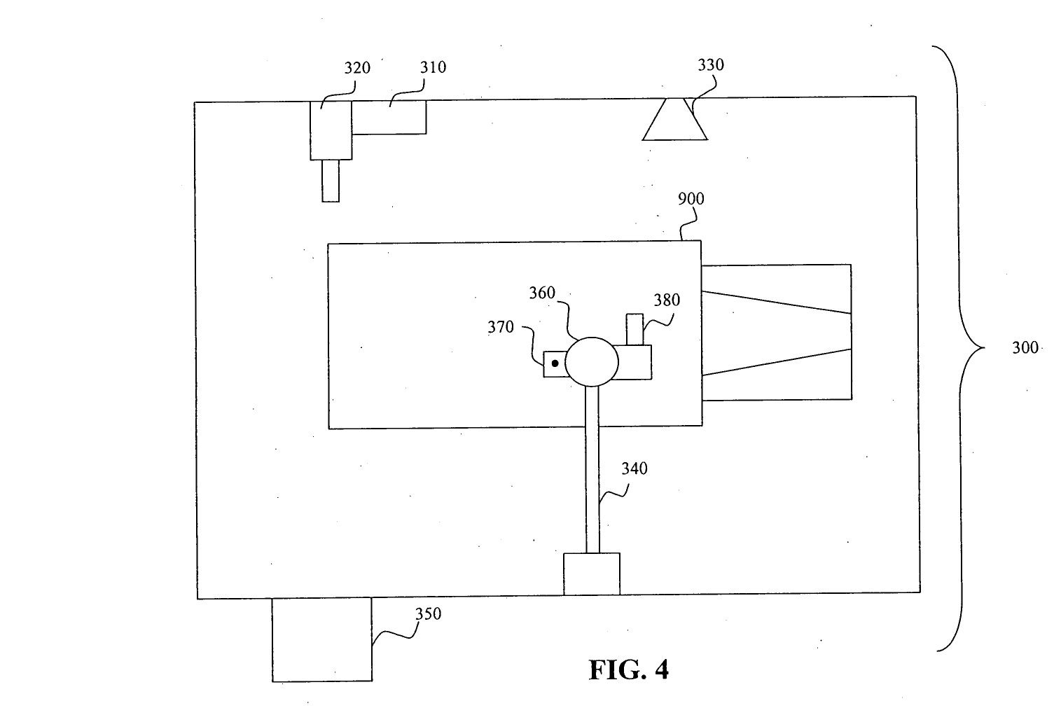

FIG. 4 shows a detailed view of an exemplary embodiment of a sampling station 300 according to the present invention. As shown in FIG. 4, the sampling station 300 includes a carrier position determining device 310 that is adapted to automatically determine a position of the carrier 900 based on an image from a camera 320. If the carrier 900 is determined not to be in the optimal predetermined position for a sample of the agricultural product to be obtained from the carrier 900, the determining device 310 issues a command to the driver of the carrier 900 to move the carrier 900 into a proper position for removal of one or more samples of product. The terminal may also include a speaker 330 located in the sampling station through which the command to the driver can be issued. However, according to the alternative embodiments of the present invention, a positioning light or a text messaging system, for example, can be utilized to instruct the driver to move the carrier to a proper position for removal of the sample of product. Alternatively, the driver can move the vehicle to a predetermined position based on visible markings present at the sampling station.

The carrier position determining device 310 may include and/or be linked to a processor or computer 350 that analyzes the image of the carrier obtained by the camera 320 and determines whether the carrier is in a proper position for product sample removal. The computer 350 may be a personal computer located in a sampling shed or office that provides the required processing to coordinate and ensure proper positioning of the carrier at the sampling station 300. In yet further embodiments, the processor may automatically direct the driver of the carrier 900 to reposition the carrier if needed.

The carrier position determining device 310 may include a wide angle vision system (e.g., an IQinvision IQeye3 camera mounted in a heated Pelco camera enclosure) mounted at a position where the determining device 310 can distinguish as much of the trailer as necessary to determine the position of the carrier and/or to provide instructions to the driver to move the carrier for sampling. The cameras are preferably mounted above the location where the carrier 900 will be positioned during sampling.

Alternatively, the carrier position determining device may include a photo-eye device. The photo-eye device may include a reflector and a receiver. A light beam is emitted at either the reflector or receiver and includes a mechanism for detecting when the light beam is broken due to, for example, interference from the carrier. The photo-eye device can be used to detect certain locations on the carrier or truck such as, for example, the front of the truck, the gap between the cab and the product holding container, and the rear of the truck.

The sampling station 300 may also include a product sample remover 340 adapted to remove a sample of product from the carrier. The product sample remover may include a probe arm 360 that is adapted to remove the sample of product. The probe arm 360, may include a hollow cylinder through which a product sample is pneumatically withdrawn and removed from the carrier. The product sample remover may be a robotic product sample remover.

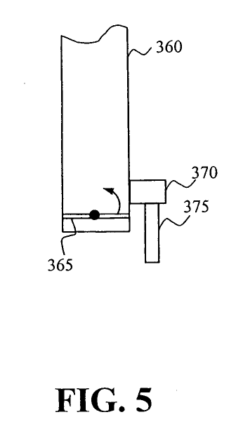

The product sample remover 340 may include a carrier container bottom sensor 370 adapted to detect the bottom of a carrier container. As shown in FIG. 5, the carrier container bottom sensor 370 includes a slender pressure/weight triggered rod 375 that is mounted on the probe arm 360. As the probe arm 360 is moved through the product carried in the carrier toward the bottom of the carrier, the resistance of the product does not normally produce a force on the bottom sensor 370 sufficient to trigger the sensor. However, once the rod 375 contacts the bottom of the container, the sensor 370 will trigger, thus generating a signal to a processor, such as sampling computer 350, to indicate that the bottom of the carrier has been reached. Alternatively; the bottom sensor may employ a hydraulic pressure sensor.

The bottom sensor 370 enables the terminal 100 to determine that the carrier bottom has been reached so that samples can be taken across or substantially across the full depth of the carrier. The product sample can be taken at specific depths and locations. For example, when the carrier container bottom sensor 370 detects the bottom of the carrier, the probe arm 360 shutter 365 opens to collect the sample of product.

The sensor 370 may be utilized to detect non-visible obstructions that may exist in the carrier 900 during insertion of the probe 360. The scope of the present invention includes terminals that operate without the carrier bottom sensor 370 or with a carrier bottom sensor 370. According to other embodiments of the invention, any means of sensing and/or otherwise determining the location or the approximate location of the bottom of a carrier can be used to practice the present invention.

The sampling station 300 may also include a probe guidance system/device. The probe guidance system/device may include a sophisticated image recognition system that includes logic to identify obstructions in or on the carrier 900. The probe guidance system/device may include a camera 380 that is adapted to obtain an image of the carrier 900. According to an embodiment of the invention, the camera 380 is also attached to the probe arm 360. The camera 380 may also be connected to a computer 350. The computer 350 may be a personal computer. The computer 350 may be a separate processor and/or may be one of the processors or computers employed in the supervisory station 600. The computer 350 may be adapted to analyze the image of the carrier obtained by the camera 380 and identify obstructions on the carrier that might inhibit movement of the probe arm to the carrier and/or to and through the product sample. Still further, the computer 350 can also be adapted to analyze the image obtained by the camera 380 to identify the presence or absence of a covering, such as a tarp, over the container of the carrier 900 that could interfere with product removal. The computer 350 can further be configured to initiate the issuance of a command to a driver of the carrier to remove the covering if the covering is identified. Other substantial mechanism for determining whether there is an obstruction on the carrier my be included in the scope of the present invention.

The probe arm guidance system/device may be adapted to guide the probe arm 360 into the carrier 900 while avoiding identified obstructions. The guidance system may include a logic routine in computer 350 and/or the computers of the supervisory station 600 that plots the identified obstructions in one, two and/or three dimensions and formulates a movement path of the probe arm 360 to the carrier 900 and through the product.

According to one embodiment of the present invention, the sampling system may be configured to first determine the positions of the carrier container holding grain. The system then operates to select sample points that are separated by a large distance. According to one embodiment, the separation between the sample points is maximized. The separation between the sample points may be limited by the container configuration and/or the movement of the probe arm or sampling device.

The probe arm guidance system/device may utilize a programmable logic controller such as for example, and Allen Bradley SLC5/04, to coordinate the movement of the probe arms. also replace RSLogix with SLC5/04 at the end of this paragraph. Celesco PT1MA and RT8420 position sensors can be utilized on existing probe arms at existing terminals for probe arm guidance control with the SLCS5/04 in position in provision systems.

As described above, movement of the probe arm 360 is in three dimensions (X, Y and Z-axis). According to one exemplary embodiment of the present invention, the probe arm may be mounted on a support structure that allows the probe to move over the top of the carrier. For example, parallel support beams may be positioned along the side of the carrier and a movable cross beam may be mounted generally perpendicular to the support beams. The probe arm may be movable mounted along the cross beam so that the probe arm may be positioned at any location (X, Y plane) overhead the carrier or truck. The probe arm is controlled to move into the carrier bed (Z direction) in order to sample the product. As mentioned above, an imaging system may be used to control movement of the probe.

The sampling station 300 may include a product evaluation device or system. The discrimination system is implemented using the camera 380 to obtain an image of the product carried by the carrier 900. The computer 350 and/or the computers of the supervisory station 600 can be adapted to identify the type of product carried by the carrier based upon an obtained image of the product by camera 380. Thus, the sampling station 300 of the present invention can be utilized to automatically identify the type of product being carried by the carrier and thus discriminate one type of product from another. For example, corn can be distinguished from beans automatically utilizing an image from the camera 380.

The product evaluation and/or probe guidance devices/systems that utilize cameras, may include both wide angle and zoom vision capability. However, certain embodiments of the invention can be practiced utilizing only include one of these vision capabilities. According to an embodiment of the present invention, the wide angle vision system may include a IQinvision IQeye3 camera cushion mounted in a heated Pelco camera enclosure directly on the sample probe arm 360. The camera 380 and its associated hardware can communicate, for example, on an Ethernet that is connected to the computer 350.

The sampling station 300 of the present invention may also include a device that is adapted to select a location or a plurality of locations in the carrier 900 from which to remove a sample of the product. The device may be a processor or computer 350, which is adapted to randomly select a plurality of locations in the carrier from which to remove the product, thus improving the accuracy of the sample with respect to the product carried by the carrier 900. According to certain embodiments of the present invention, random sample locations are obtained based on a random numeric generator, as would readily be understood in the art. Alternatively, the sample locations cab be selected utilizing a series of pre-programmed locations, wherein the number of variations of these pre-programmed locations is high enough that an observer would not be able to determine where the probe will move next unless he or she makes extensively studies the sampling station over a period of time. Alternatively, a combination of random and pre-determined sample locations may be utilized determine where to obtain a sample from the carrier 900. However, any method or apparatus that will permit the sampling station 300 to obtain a sample of product from a location that will be unpredictable by the driver of the carrier can be used.

The product sampling system described herein may be employed at various agricultural product handling facilities such as, for example, soybean or corn crushing plant or ethanol plants.

The terminal 100 may include a gate that can be lowered or otherwise positioned in front of the carrier 900 during product sample removal. The gate may provide the driver of the carrier a visual warning that he or she should not move the carrier during the sampling process. The gate may be lowered before the probe arm is directed into the carrier and remains lowered until the probe arm is removed from the carrier.

Some or all of the various components of the carrier position determining device 310 may be operatively connected, for example, through an Ethernet network. In other embodiments, wired communications systems can be used. In other embodiments, a combination of the two can be used.

The terminal 100 further includes a product evaluation station 400. Product quality or grade determination will be discussed in more detail below. However, in sum, a product quality value is assigned to a product based on various features of the product such as, for example, percent moisture and/or percent foreign matter and/or a product grade. Thus, any system/device/method that can be utilized to evaluate the product so that a price can be determined/estimated for the carrier can be used in the present invention. In some embodiments of the invention, these systems/devices/methods are performed automatically. In other embodiments of the present invention, they are performed manually. In still other embodiments of the present invention, they are performed in a combination of manual and automatic activities.

The product evaluation station 400 may include a processor or computer 406 to control the product grading process. A product sample taken from the carrier 900 by the probe arm 360 at the sampling station may be pneumatically transported or otherwise conveyed to the product evaluation station 400 where the product sample is evaluated. The product sample may be automatically transported to the product evaluation station 400. A function of the product evaluation station 400 is to estimate the quality of the product contained in the carrier 900 and to assign a quality value or grade to the product in the carrier.

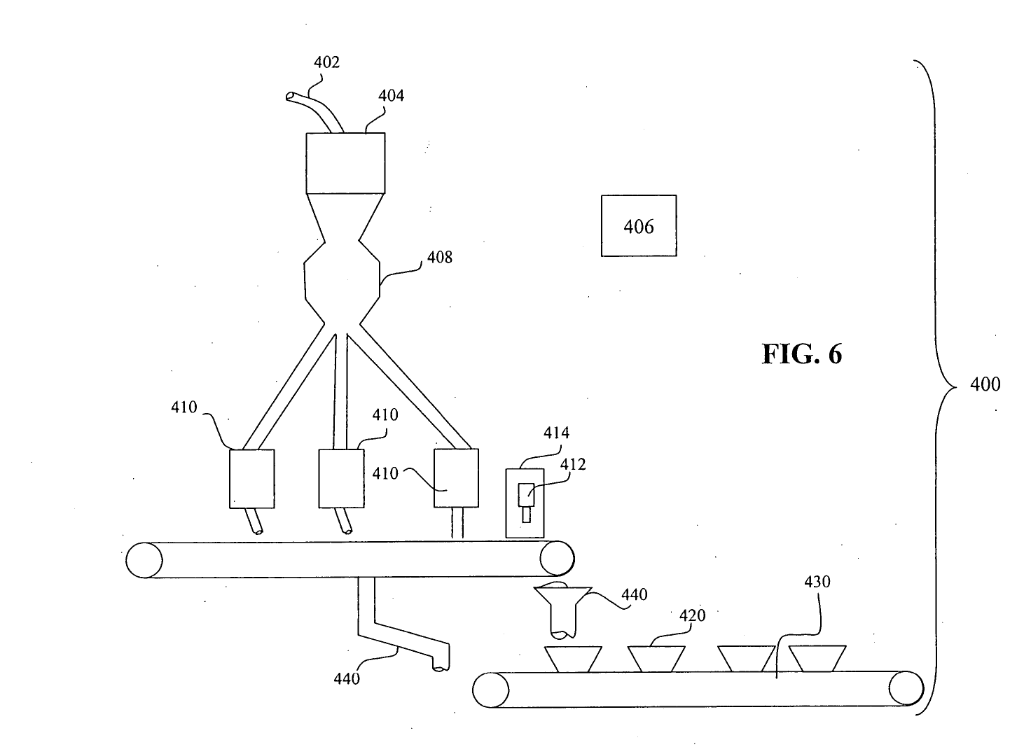

Specific features of a product evaluation station 400, according to some embodiments of the present invention, will now be discussed in greater detail in reference to FIG. 6. As can be seen in FIG. 6, sample product from the probe arm 360 is delivered through product conduit 402 to product receiver 404. The product sample may be delivered to the receiver 404 pneumatically, although other embodiments of the invention can utilize a different conveyance means. The station 400, or more specifically, a processor or computer 406 that assists in controlling and/or managing the operation of the product evaluation station 400 can be notified of the type of product that has been sampled by the probe arm 360 based on the results from the product discrimination device/system in the sampling station 300. The product sample can be automatically directed by router 408, based on the type of product, to various screening units 410. Directing of the product at router 408 may be performed utilizing, diversion gates in the router 408. Some embodiments of the invention include a heater coupled with a blower (not shown) to warm the samples to a temperature that is conducive for evaluation of the product in the product evaluation station. In some embodiments of the invention, the heater is placed at or above the router 408, although in other embodiments of the invention the heater and the blower can be placed at other locations.

As shown in FIG. 6, there may be a plurality of screeners 410 (i.e., evaluation devices). The screeners 410 may be separate from each other and are uniquely assigned to handle different types of product. For example, one screener can be adapted to screen or evaluate wheat, while another screener 410 can be adapted to screen or evaluate corn and soybeans. Alternative embodiments of the present invention also include a screener that is adapted to screen or evaluate any type of product for characteristics such as, for example, percent moisture content and test weight, that are common and can be performed utilizing the same screener for almost any type of product. Still, in other embodiments of the present invention, separate screeners can be used even if there are characteristics of the product that can be determined utilizing the same screener.

According to an embodiment of the invention, there is one or more screeners 410 that are adapted to automatically determine the moisture content and/or a test weight of the sample of product obtained from the carrier 900. The test weight of the sample of product comprises at least one of density and weight by volume of the product. The screeners 410 may be configured to determine the percentage of foreign material that is present in the product sample delivered to the product evaluation station 400.

The product evaluation station 400 may also be configured to provide clean samples of the product removed from the carrier for evaluation. Thus, some or all, of the foreign material contained in the product sample is removed. The amount removed may be utilized to determine the percentage of foreign material contained in the sample. The separation of the foreign matter may be performed prior to the product reaching the screeners 410 by, for example, a centralized foreign matter removal device that is common to all types of products. Alternatively, the foreign matter may be removed utilizing foreign matter removal devices that are individualized for specific types of product. In other embodiments of the invention, the foreign matter removal devices can be integral with the screening devices 410.

The samples of product, or at least a portion of the sample of product removed from the carrier 900, may be directed to a product grade analyzer 412. The product grade analyzer 412 may be configured to analyze the product and determine a grade of the product. The product grade analyzer 412 may include a camera 414 adapted to obtain an image of the product that is conveyed to product analyzer by a conveyer belt 416. The image of the product obtained by the product grade analyzer is compared to recorded historical images of product that have previously had a product grade assigned to those images to determine the product grade. Thus, in some embodiments of the invention, the product grade analyzer is in communication with computer 406 or another device, such as the processors or computers of the supervisory station 600. The computer may include logic that recognizes features of the product captured in the image of the product sample and compares these to the historical product features to assign a product grade to the sample. In other embodiments of the present invention, the product grade analyzer 414 may utilize a manual system where terminal personnel compare the sampled product to historical product samples and manually assign a product grade to the sampled product.

After the product grade has been determined, the information obtained during evaluation of the product may be communicated to supervisory station 600 where it may be stored in a data storage device.

Some of the specific features of the product grade analyzer 412 will now be discussed. The camera 414 of the product grade analyzer, may be a Sony DFW-SX900 camera that is adapted to capture one or more views of a presented sample. The product grade analyzer 412 may also include software that is employed to analyze the views to determine such features of the product such as, for example, color, discolorations, and kernel or potential kernel damage, size distribution of the products in the sample, percentage of large foreign matter material that is still present in the sample, and percentage of broken product that is in the sample. Based on one or more of the features of the product analyzed at the product analyzer, a product grade will be determined by the product analyzer 412.

The product grade obtained by the product analyzer 412 may be combined with features determined from the other product evaluation activities, such as percent moisture and test weight evaluation and percent foreign matter. The various characteristics of the product sample can be combined to determine the product quality value. This determination can be performed by, for example, the computer 406 and/or the computers of supervisory station 600. After the product samples have been evaluated in the evaluation station, the samples may be dropped into containers 420 on conveyor belt 430. Gates 440 may be utilized to control the deposit of the sample in the containers 420 on the conveyer belt 430.

Product samples of identified lower quality may be transported by the conveyer belt 430 to storage containers where the discounted product samples can be stored for future reference or further analysis. Alternatively, these product samples may be discarded. Thus, the present invention provides for retaining the product samples if needed. Identification tags can be placed onto the product containers as needed.

The evaluation station, may have terminal personnel assigned and/or working in the product evaluation station 400. For example, the product evaluation station 400 can include a product evaluation operator display terminal such as, for example, personal computer that is adapted to perform and/or control some or all of the analysis, and/or to output the results of the analysis and/or the status of the evaluation of the product. However, the evaluation station may also be fully automated.

The product evaluation station 400 enables a consistent product quality to be determined between product samples, thus eliminating or substantially reducing the subjective evaluation of a human analyst. The product evaluation station may be operated 24-hours per day, and will yield consistent results so that the product evaluation results does not vary between shifts or based on individual subjective standards.

The results of the product evaluation (the product quality value and/or the raw data used to determine the product quality value, such as product grade, percent moisture, etc.) may be directed to a computer, which in some embodiments is located in the supervisory station 600. The handling of the results can be performed electronically without the need for manual data entry and/or hard copy paperwork The information obtained from the product evaluation station 400 may be directly linked with customer database information utilized by the operators of the terminal 100. For example, remote access (e.g., via the internet) to the evaluation results may be provided.

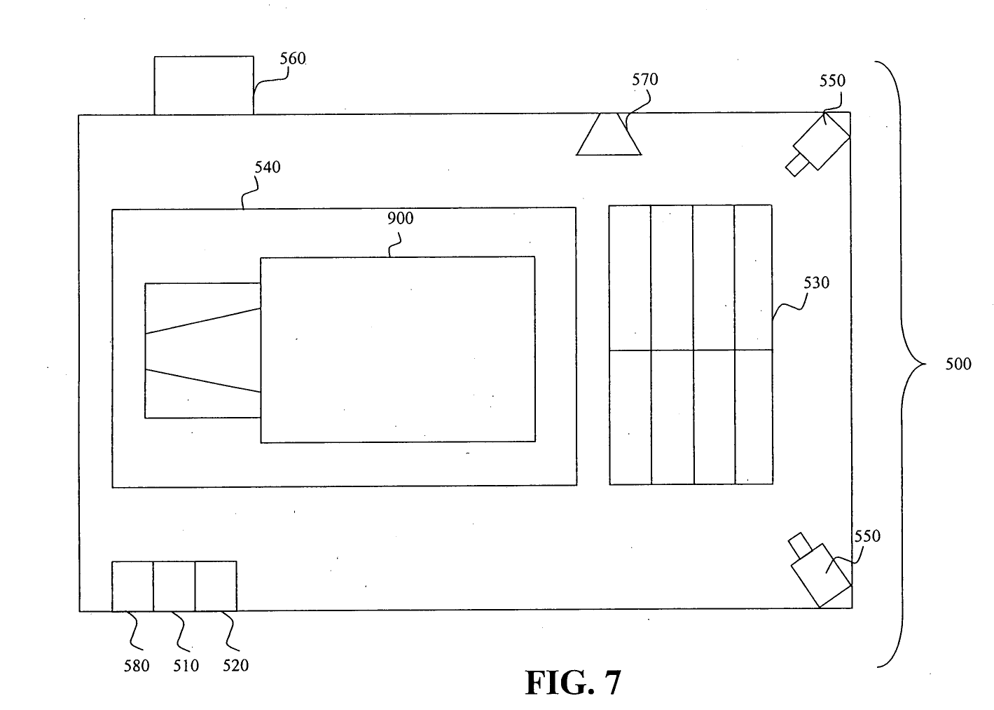

The terminal 100 according to an embodiment of the invention includes a product unloading station 500 as shown in FIG. 7. The product brought to the terminal by the carrier 900 is deposited at the product unloading station 500. In addition, the carrier 900 checks-out of the terminal 100 at the unloading station 500. The product unloading station may be any station that permits a carrier 900 to unload its load of product at the terminal 100. The terminal 100 is configured to both permit the carrier 900 to deposit its product and determine the weight of the product deposited at the terminal.

The terminal 100 is adapted to direct a carrier 900 to a particular unloading station of the terminal in an automated manner. The carrier 900 is assigned to a particular product unloading station based on the type and/or quality of the product carried by the carrier 900. The assignment is performed in close temporal proximity to when the product type and quality is determined in the sampling station 300 and the product evaluation station 400, respectively. The supervisory station 600 assigns the carrier 900 to a particular product unloading station 500. The computer(s) in the supervisory station 600 may be utilized to select the location.

The product unloading station 500 may include a terminal 510 which is similar to and/or the same as the terminal of the carrier check-in station 200. Also, the carrier unloading station 500 may include an input device such as an identification record reader 520 adapted to read the memory of the identification record 270 issued to the driver of the carrier 900 at the check-in station 200. The record 270 may include the code assigned to the carrier by the terminal. The identification record reader 520 is adapted to read a magnetic swipe card, again issued at the carrier check-in station 200. The product unloading station 500 may retain the identification record for recycling and/or additional later use.

At the terminal 510, the driver of the carrier 900 may be provided with the results of the evaluation of the product for his or her load. After receiving the results, the driver can be queried to confirm his desire to unload the product based on the results of the product evaluation.

The product unloading station 500 may also be configured to check the identity of the carrier 900 by reading the identification record 270 placed in the identification reader 520. The unloading station 500 may also be also configured to determine whether the carrier 900 is in fact the carrier that is anticipated to be at the product unloading station 500. The supervisory station 600, in some embodiments, keeps track of the movement of carriers through the terminal 100 and can prepare the various stations for the arrival of a given carrier, as discussed in greater detail below. The terminal will have more than one carrier depositing product at the terminal 100 at any given time (and would typically have many carriers depositing product at any given time) Thus, it is possible for the order of carriers waiting to deposit product at the product unloading station 500 to change and/or the driver of the carrier could drive to the wrong product unloading station 500. If the carrier 900 is not the anticipated carrier, then the unloading station may operate to redirect the carrier 900 to another unloading station and/or switch or adjust a receiving bin at the product unloading station 500 so that the product will be taken to the proper deposit area (e.g., bin, barge, etc.) at the terminal 100.

As noted above, the terminal 100 is configured to notify the driver of the carrier of the grade assigned to the product being carried. If the driver of the carrier 900 determines that he does not want to dump the load of product at the terminal 100, the terminal 100 can be configured to permit the driver of the carrier to not unload the product and instead to direct the carrier 900 to an exit of the terminal 100. The supervisory system 600 can be configured to record this event and adjust the terminal 100 operations accordingly, if necessary. It is further noted that the driver of the carrier 900 can be notified of this information prior to arriving at an unloading station 500, such as, for example, at the sampling station, and thus the check-out of the carrier 900 could be performed at a station that, for example, only has a terminal 510 and a card reader 520. Thus, as shown in FIG. 1, the carrier be directed to a path 102 permitting exiting of the terminal prior to entering the unloading station 500.

If the driver of the carrier decides to unload the product at the terminal 100, the driver will be instructed when to dump the product at the dump area 530 so that the weight of the product can be determined by bulk weight scales (not shown) at the terminal 100. Alternatively, the product unloading station 500 may be configured with carrier scales 540 that are configured to weigh the carrier 900 fully loaded and again after the product is unloaded. The unloading station 500 may determine the difference in weight from before unloading and after unloading in order to determine the weight of the product deposited at the terminal 100. The product unloading station 500 may be configured to notify the driver that the terminal is ready to weigh the carrier and then notify the driver to dump his or her load of product and then notify the driver that the carrier will again be weighed after the product has been unloaded. At each point in the unloading process, instructions may be provided to the driver from the unloading station 500 in visual or audio format.

The unloading station 500 may be configured with WeightTronix WI-130 scale systems and/or Fairbanks R2500-F2 scale systems. In addition, certain embodiments may be provided with software that will enable the servicing of two scales.

The terminal 100 may be configured to determine whether or not the carrier 900 is in an acceptable position (e.g., correctly positioned on a weighing platform) on the scale 540 to determine the weight of the carrier 900. For example, the unloading station 500 can use the same system or a similar system as the carrier positioning device/system used at the sampling station 300. As with the sampling station 300, the unloading station may utilize cameras 540 to obtain an image of the carrier 900, from which information relating to the position of the carrier can be determined. This image captured by cameras 550 may be analyzed utilizing a computer 560 to determine whether or not the carrier is in an acceptable position to commence weight measurement. Motion sensors and loaded/unloaded carrier type and load comparison weights can be used in addition to cameras or in lieu of cameras to determine if the carrier 900 is in a proper position for taking weight measurements.

If it is determined that the carrier is not in an acceptable position to be weighed, a command can be automatically sent to the carrier operator providing instructions for repositioning the carrier. Thus, the station may include an audio system 570 so that the driver can receive audio instructions and/or a visual system for providing the driver with visual instructions. The scope of the present invention includes any device that will determine whether a carrier 900 is in proper position to be weighted and or to deliver instructions to a driver of a carrier reposition his or her carrier 900 can be used to practice the present invention.

Several embodiments of the present invention may use the just described carrier position determination system/device to determine whether or not the carrier 900 is in proper position for dumping.

The cameras 550 may be mounted at the rear of the scale 540 and/or the rear of the dump area 530 on either side of the scale and/or dump area facing the location where the rear of the carrier 900 would be located during weighing and/or dumping. The terminal 100 may be configured to capture and save the images obtained by cameras 550.

The product unloading station 500 may be automated so that images obtained by cameras 540 can be used to determine the type of carrier 900 that is located at the station. For example, different procedures can be used if the carrier is an end type dump truck. Alternatively, the type of carrier can be determined based on input received from the driver and/or the scan of the delivery receipt at the check-in station 200. The product unloading station 500 may be further configured, so that to terminal personnel may be automatically alerted to potential problems so that prompt assistance may be provided to the carrier operator.

After the carrier has deposited its load of product, the product unloading station 500 can automatically direct the driver to reposition the carrier, if necessary, the carrier can again be weighed and the amount of product deposited at the terminal 100 can be determined. Images of the carrier being weighed can also be captured utilizing the cameras 550 to record the weighing procedure.

The product unloading station 500 can be configured with an output device such as a ticket printer 580 that prints a detailed ticket concerning information about the product deposited at the terminal 100. The ticket may include information regarding any or all of the above discussed results of the product sample evaluation as well as the weight of the product deposited at the terminal 100. The ticket printer 580 may be located in a variety of locations. In the case of stations using carrier scales 540, the ticket printer 580 may be mounted in or with the terminal 510. In stations using bulk weight type dump scales, the ticket printer 580 can be mounted separate from the input terminal 510 or with the input terminal 510. When the ticket printer is positioned separately from the terminal 510, the ticket printer may be positioned away from the dump area 530 a sufficient distance so that the carrier 900 can pull ahead after dumping and wait for the ticket to be printed, thus enabling another carrier 900 to begin the dumping or unloading sequence. Thus the flow time through the terminal 100 may be reduced. Two carriers may be in process at the same time at one station.

A plurality of tickets may be printed for each product deposit. One or more tickets can be printed by the ticket printer 580 and provided to the driver of the carrier 900. In addition, one or more tickets can be printed at another printer or a plurality of other printers at the terminal 100 so that a hard copy can be retained for record purposes. Okidata Microline 184 printers may be utilized. Although, the invention is not limited to one printer model or make. A serial splitter may be utilized to allow operation of a plurality of printers with one print command.

As noted above, the terminal 100 is adapted to convey the product from the dumping area 530 to a desired product bin and/or a product transporter, such as by way of example, a ship or train, or a truck. The terminal 100 may also be adapted to direct the product to a specific product bin based on the type of product and/or the quality of the product. Different product deposits may be directed to different product bins 532 from the same dumping station and, the same dumping station may be utilized to handle different types of product and/or different qualities of product.

The check-out station may be located separately from a dumping station. In such a system, components that are applicable to dumping operations and check-out operations could be provided at each separate station. As shown in FIG. 1, after completion of the unloading and/or check-out operations the carrier could be directed to a path 101 to exit the terminal.

The terminal 100 may also include a supervisory system station 600. The supervisory station 600 in can coordinate some or all of the activities and/or stations and/or systems/components of the terminal 100. The supervisory system 600, may be fully automated and, thus, require no terminal personnel to work at the station, except for, perhaps, as necessary to perform system maintenance and/or to upgrade software or other subcomponents of the supervisory station 600.

The supervisory station 600 may include one or more computers or processors. At least one of the computers may be configured to manage a database containing data received from and/or provided to such components as the input terminal 240 of the check-in station 200, the ticket printer 580 of the product unloading station 500, the components of the sampling station 300 and/or the product evaluation station 400, the terminal 510 at the product unload station, some or all of the various computers of the terminal 100, outside terminal computer systems, and some or all of the components and/or stations at the terminal 100. Thus, the supervisory station 600 can be in communication with some or all of the above mentioned components, just as the supervisory station 600 can be in control or share control with these components.

The supervisory station 600 can be configured to include or have access to or otherwise communicate with a bin board spreadsheet that will permit terminal personnel and the supervisory station 600 to view and/or determine the current operating status of product bins of the terminal and the carrier location information for carriers within the terminal as well as data for some or all of the carriers in the terminal. In addition, the supervisory station 600 may receive live and/or recorded videos from some or all of the cameras in the terminal 100; a list of some or all of the atypical situations that might arise in the terminal; information concerning the quality of product delivered by a carrier; information regarding product source of product from a carrier and/or quality of product delivered by a given carrier, delivered weights; shipper information, driver information, product receiving bin information and information regarding direct transfer to a product transporter such as a ship or a train or another truck; information received from an outside system, such as current customer information, discount information, weight information, grade and quality information, etc.

The supervisory station 600 may also be configured to be periodically queried or contacted by an outside system or another system within a terminal to extract information and/or input information into the supervisory station 600.

The supervisory station 600 may supervise and/or coordinate and/or control maintenance functions and/or identify maintenance needs at the terminal 100 and or report these to terminal personnel and/or outside systems.

The supervisory station 600 may also include a spreadsheet (e.g., the bin board spreadsheet for tracking measured levels of product in the product bins of the terminal 100). The information that may be obtained from a bin board spreadsheet of the supervisory station 600 may include: an assignment priority indicating the order to fill bins assigned to a given product type and/or quality of product, the level in one or more or all of the bins in the terminal 100 as of the last time the bin was measured (which in some embodiments can be performed manually, based on feedback from a bin top operator, while in other embodiments might be performed automatically), the time that the bin level was last measured, information regarding the current capacity in one or more of the bins (this can be expressed in terms of carrier loads, weight, volume, etc.), current carrier assignments to the unloading stations and/or dump areas, desired position and/or current position for a given tripper and a purge status of one or more of the conveyors in the terminal 100. The supervisory station 600 may be adapted to designate a bin to receive each carrier load. The designation may be performed, for example, by utilizing the product type and product quality determined by the sampling station/product evaluation station. The supervisory station 600 may be configured to automatically assign a given load of product to a product bin that has the highest priority available from the bin board spreadsheet. The supervisory station 600 may also be configured to monitor the bin board spreadsheet and prompt a measurement of a bin to be taken and/or to prompt a conveyor system to be placed in the purge state and also to alert a bin top operator when and where to move a tripper.

The supervisory station 600 may be configured to provide overall coordination of information and management of that information to operate the terminal 100. Thus, any device/system that can be configured to control some or all of the stations/sub-systems of the terminal 100 can be utilized as the supervisory station.

The product bins of the terminal 100 may be measured or otherwise operated by terminal personnel. In addition, product conveyors may be tripped by terminal personnel. Thus, in some embodiments of the present invention, there will be bin top operation terminal stations that will be provided for the use of the terminal personnel to communicate and/or coordinate with the supervisory station 600. These terminals can be portable and/or hand held. The supervisory station 600 may be configured to alert the operator via the bin top operations terminal station when a level measurement in a product bin should be taken and/or when a tripper needs to be relocated and/or where. A bin top operation terminal may include a portable terminal which can communicate with the supervisory station 600 via a wireless interface. For example, a Internec wireless PDA model 2545CS or 5020 may be used to interface with the supervisory system 600 via a wireless Ethernet. The terminal can be used to provide a bin top operator with a view of any part of the bin board spreadsheet and to request level measurements by the bin top operator and provide for entry of bin level measurements by the bin top operator and/or display to the bin top operator anticipated tripper moves, as well as alert an operator when a conveyor has been purged and that a tripper can be moved and/or provide bin top operator confirmation when a move has been completed.

It is noted that the various embodiments of the present invention described above include stations that may be separate from each other. However, it is noted that in some embodiments of the invention, a single station could fulfill the role of a plurality of stations. Thus, the present invention is not limited by the location/function of a given station. For example, a check-in station 200 and a product sample station 300 could be combined with a station that performs both check-in of a carrier and sampling of the product from a carrier. Still further, it is noted that some embodiments of the present invention can be practiced with stations that have more or less capabilities than the stations described above, as well as stations where capabilities are duplicated, etc.

Also, the above discussion refers to the stations in the singular. However, the present invention includes a system having a plurality of any or all of the above mentioned stations/components, etc. For example, a terminal 100 according to an embodiment of the present invention could include three carrier check-in stations 200, six sampling stations 300, seven product evaluation stations 400, fifteen product unload-stations 500.

The present invention also includes a control system that controls some or all of the activities of the terminal 100. In a first embodiment, the control system is the supervisory station 600, as discussed above. In some embodiments, one or more computers are utilized to implement the control system. Thus, the present invention may include software and/or logic routines that can be utilized to control the terminal 100 of the present invention or otherwise implement the present invention.

Reference is made above to numerous computers or processors. It is noted that the scope of the present invention is not limited by the location of the computer(s) and/or the number of computers. For example, a single computer could be used for both the check-in station and the sampling station 300, or separate computers could be used. Still further, a plurality of computers could be used at a given station. Still further, the computers of the terminal 100 could reside in one computer at the supervisory station 600.

As discussed above, the terminal 100 can be operated in an automatic manner. However, it is noted that even in a fully automated system, the presence of terminal personnel may still be required to run the terminal 100. For example, terminal personnel might be required to perform maintenance on the components of the terminal 100, resolve abnormalities and respond to accidents and/or assist carrier operators, confirm the remaining capacity of bins, etc.

As discussed above, the terminal can be configured so that some or all of the various sub-systems/components can communicate via a network. The systems and components may be connected via a wireless system, which in some embodiments is an Ethernet system. However, other embodiments can utilize wired systems.

Given the disclosure of the present invention, one versed in the art would appreciate that there may be other embodiments and modifications within the scope and spirit of the present invention. Accordingly, all modifications attainable by one versed in the art from the present disclosure within the scope and spirit of the present invention are to be included as further embodiments of the present invention. The scope of the present invention accordingly is to be defined as set forth in the appended claims.

1. A system for handling an agricultural product comprising:
an interface unit adapted to convey information to and accept input from an operator of a carrier of the agricultural product;
a carrier position determining device adapted to determine the position of the carrier;
a product sample probe and a guidance device adapted to guide the probe to sample the product located in the carrier; and
a product evaluation system adapted to evaluate the sampled product.

2. A system for handling an agricultural product, comprising,
a product sample remover adapted to remove product from a carrier;
a guidance system adapted to guide the sample remover into the carrier while automatically avoiding obstructions.

3. The system of claim 2, wherein the product sample remover is adapted to pneumatically transport a sample of the product from the carrier to a system for evaluating the product.

4. The system of claim 2, further comprising a product evaluation system, and wherein the handling system is adapted to automatically transport the product sample to the product evaluation system.

5. The system of claim 2, further including a display, and wherein a processor is operatively connected to the display so that information regarding the product quality can be viewed by an operator of the carrier.

6. The system of claim 3, further including a display, and wherein a processor is operatively connected to the display so that information regarding the product quality can be viewed by the driver of the carrier.

7. The system of claim 4, further including a display, and wherein a processor is operatively connected to the display so that information regarding the product quality can be viewed by an operator of the carrier.

8. The system of claim 2, further comprising a carrier position determining device that determines the position of the carrier, and, if the carrier is not in proper position, directs the carrier to move into a proper position for removal of the sample of product from the carrier.

9. The system of claim 8, wherein a camera is used to determine the position of the carrier.

10. The system of claim 2, wherein the product sample remover comprises a probe arm adapted to remove the sample from the carrier.

11. The system of claim 10, wherein the guidance system comprises a camera adapted to obtain an image of the carrier.

12. The system of claim 11, wherein the guidance system further comprises a processor adapted to analyze the image of the carrier and identify obstructions on the carrier that might inhibit movement of the probe arm to the product sample.

13. The system of claim 2, further comprising:
a camera adapted to obtain an image of product carried by the carrier; and
a processor adapted to identify the type of product carried by the carrier based on the obtained image of the product.

14. The system of claim 2, further comprising a processor adapted to randomly select a plurality of locations in the carrier from which to remove the product.

15. The system of claim 2, wherein the product sample remover includes a sensor adapted to detect the bottom of a carrier container.

16. The system of claim 2, further comprising a processor configured to control the product sample remover to remove a representative sample of product and wherein the processor is adapted to receive a signal from a carrier container bottom sensor indicative of the location of at least a portion of the product sample remover with respect to the carrier container bottom.

17. The system of claim 4, wherein the product evaluation system is adapted to determine at least one of the moisture content, percent foreign matter, and a test weight of a sample of product obtained from the carrier.

18. A system for handling an agricultural product comprising:
a check-in station that includes a device configured to record a visual image of a product carrier;
a sampling station configured to automatically sample a product contained in the carrier and including a device for transporting a sample of product to a product evaluation system; and
a station for unloading the product contained in the carrier;
wherein the system is configured to include a device for automatically directing the carrier to the unloading station based on results of an evaluation of the product sample conducted by the evaluation system.

19. The system of claim 18, wherein the recording device at the check-in station is configured to capture the license plate of the carrier.

20. The system of claim 18, wherein the sampling station includes a processor for analyzing an image of the carrier and identifying obstructions from the image on the carrier that might inhibit movement of a product sample remover and for guiding the sample remover into the carrier while avoiding identified obstructions.

21. The system of claim 18, wherein the product evaluation system is configured to determine a grade of the product sample and wherein the system includes an output device for conveying the grade of the product sample to the operator of the carrier.

22. The system of claim 18, wherein the unloading station includes a visual imaging device and a processor for determining whether the carrier is in a proper position to unload the product and wherein the unloading station includes an output device for directing the operator of the carrier re-position the carrier if necessary.

23. A system for handling an agricultural product comprising:
a check-in system adapted to check-in a product carrier driver at a product terminal; wherein the check-in system includes a carrier identification system adapted to identify the product carrier using a visual image;
a product carrier positioning system adapted to determine whether the product carrier is in an acceptable position for product sampling;
a product sample probe guidance system adapted to guide a product sample probe to and from the product carrier using an visual image and obtain a sample of product while avoiding obstructions on the product carrier; and
a product evaluation system adapted to determine the type of sampled product based on a visual image of the product.
